(19) United States
(12) Patent Application Publication
(10) Pub. No.: US 2018/0209787 A1
(43) Pub. Date: Jul. 26, 2018

(54) METHOD FOR DETECTING CHANGE IN UNDERGROUND ENVIRONMENT BY USING MAGNETIC INDUCTION, DETECTION SENSOR AND DETECTION SYSTEM

(71) Applicant: Korea Institute Of Geoscience And Mineral Resources (Kigam), Daejeon (KR)

(72) Inventors: Dong-Woo RYU, Daejeon (KR); Eunhee KIM, Daejeon (KR); Kisong LEE, Gunsan-si (KR); Byoung-Woo YUM, Daejeon (KR); Inhwan Lee, Daejeon (KR); Jaehum LEE, Daejeon (KR); Sueng Won JEONG, Daejeon (KR); Hong-Jin LEE, Daejeon (KR); Byeongju JUNG, Daejeon (KR); Eun Seok BANG, Daejeon (KR); Wonkyu CHOI, Daejeon (KR)

(21) Appl. No.: 15/745,293

(22) PCT Filed: Oct. 19, 2015
(86) PCT No.: PCT/KR2015/011002

§ 371 Date: Jan. 16, 2018

(30) Foreign Application Priority Data
Jul. 14, 2015 (KR) 10-2015-0099780
Jul. 14, 2015 (KR) 10-2015-0099781

(51) Int. Cl. G01B 15/06; G01N 23/18; G01V 3/30; G01V 3/38

(52) U.S. Cl. CPC G01B 15/06; G01V 3/38; G01V 3/30; G01N 23/18

(57) ABSTRACT

Provided is an underground environment change detection method including: repeatedly sensing an AC signal propagated through an underground in a magnetic induction manner; and monitoring an underground environment change from a change in the AC signal.

### TECHNICAL FIELD

The present invention relates to a method, sensor, and system of detecting an underground environment change using magnetic induction.

### BACKGROUND ART

It is reported often recently that sinkholes occur in a downtown area. Sinkholes sink when the cavity in the underground does not withstand the weight of the ground or structure, and mean a large hole connected to the surface.

If an underground event such as a sinkhole occurs in an upscale modern city, property damage as well as personal injury may occur.

It is studied that underground events such as sinkholes may be caused by artificial factors such as large-scale civil works in addition to natural phenomena. As a result, residents in areas where large-scale civil works are in progress often suffer from anxiety that they will not know when a sinkhole will occur, resulting in a large social issue.

Therefore, there is a need for a technology to monitor the underground environment change in order to solve the public anxiety and to minimize the human and material damage caused by the underground event.

Korean Patent Application No. 10-2013-0051175 discloses “system for probing underground facility by signal processing of GPR probing device”. The prior art GPR probing device includes a miniaturized device by loading a probing device on a cart and moves the miniaturized probing device on the ground to detect an abnormality of the underground facility.

However, since the prior art underground burial inspection device requires the operator to directly move the cart, there is a spatial limitation that it is difficult to monitor a wide area, and since it needs to use human labor force, there is a time limitation that it may not be monitored 24 hours a day.

Therefore, the inventor of the present invention has studied for a long time to solve such a problem, developed through trial and error, and finally completed the present invention.

### DISCLOSURE OF THE INVENTION

### Technical Problem

An object of the present invention is to provide a method for detecting a change in underground environment by analyzing a path loss of a signal sensed by a magnetic induction method.

Underground environment changes may include changes in geological environment of underground space, groundwater distribution changes, changes in urban structures including urban railways and surrounding undergrounds, and water and sewage pipe condition changes, but are not limited thereto.

On the contrary, other objects of the present invention which are not explicitly stated will be further considered within the scope easily deduced from the following detailed description and the effects thereof.

### Technical Solution

To achieve these and other advantages and in accordance with the purpose of the present invention, as embodied and broadly described, there is provided an underground environment change detection method including: repeatedly sensing an AC signal propagated through an underground in a magnetic induction manner; and monitoring an underground environment change from a change in the AC signal.

The monitoring of the underground environment change may include determining that an underground environment change occurs when the AC signal is out of a threshold range.

The monitoring of the underground environment change may include warning an occurrence of an underground environment change when the AC signal is continuously increased or decreased more than a threshold count.

The monitoring of the underground environment change may include: measuring a path loss change amount according to a change in a medium property on a path through which the AC signal propagates, from a change in the AC signal; and detecting an underground environment change by using the path loss change amount.

The method may further include matching an impedance between detection sensors transmitting and receiving an AC signal before the sensing of the AC signal.

According to another aspect of the present invention, there is provided an underground environment change detection sensor including: a coil part configured to sense an AC signal propagated through an underground in a magnetic induction manner; and a control part configured to repeatedly sense the AC signal to measure a change amount of the AC signal.

The coil part may sense the AC signal in a magnetic resonance manner.

The coil part may include a first coil part and a second coil part having an inductance greater than that of the first coil part.

The first coil part may be a spiral coil and the second coil part may be a helical coil.

The second coil part may be interlocked with at least two first coil parts to sense the AC signal.

The sensor may further include a matching part including at least one variable capacitor, wherein the control part may adjust a capacitance of a variable capacitor to perform impedance matching with another underground environment change detection sensor.

The coil part may include at least two coils spaced apart from each other in an underground depth direction.

According to a further another aspect of the present invention, there is provided an underground environment change detection system including: a plurality of underground environment change detection sensors configured to repeatedly transmit and receive an AC signal propagated through the underground in a self-induction manner; and an underground environment change detection server configured to monitor an underground environment change from a change in the AC signal received by the plurality of underground environment change detection sensors.

According to a further another aspect of the present invention, there is provided an underground environment change detection system including: at least one first detection sensor configured to transmit an AC signal in a magnetic induction manner; at least one second detection sensor configured to sense the AC signal propagated through the underground, being spaced apart from the first detection sensor; and an underground environment change detection server configured to repeatedly measure a change amount of the AC signal sensed by the second detection sensor to detect an underground environment change.

The underground environment change detection server may monitor at least one of changes in geological environment of underground space, groundwater distribution changes, deformations of underground structures including at least one of water supply and drainage pipes, gas pipes, oil pipelines, electric lines, and urban railways, and their surrounding ground changes.

### Advantageous Effects

The present invention has the effect of detecting a change in the underground environment by magnetic induction, preferably magnetic resonance. Conventionally, since there is no case of detecting a change in underground environment by using the path loss of a signal transmitted in a self-induction manner, the present invention proposes a completely new method of detecting a change in underground environment.

In addition, the present invention has an effect of monitoring underground environment changes in a specific area in real time and continuously. Because sensors are buried in the ground, it is possible to periodically measure changes in underground environment through the sensors. Therefore, the present invention does not need to measure changes in underground environment while manually moving a measurement device using a vehicle or the like.

In addition, the present invention has an effect of three-dimensionally detecting changes in underground environment of a specific area. This is because the detection sensor of the present invention is capable of creating a three-dimensional map for changes in underground environment because the sensor(s) are buried in the z-axis direction as well as the x- and y-axis directions, which constitute the horizontal plane.

On the other hand, even if the effects are not explicitly mentioned here, the effects described in the following specification, which are expected by the technical characteristics of the present invention, and the provisional effects thereof are handled as described in the specification of the present invention.

### BRIEF DESCRIPTION OF THE DRAWINGS

FIG. 1 is a view illustrating an underground environment change detection system in an embodiment of the present invention.

FIG. 2 is a view illustrating an underground environment change detection sensor buried in the underground according to an embodiment of the present invention.

FIG. 3 is a view illustrating the configuration of an underground environment change detection sensor according to an embodiment of the present invention.

FIG. 4 is a view illustrating a control part configuration of an underground environment change detection sensor according to an embodiment of the present invention.

FIG. 5 is a view illustrating signal processing of a transmission unit and a reception unit according to an embodiment of the present invention.

FIG. 6 is a view illustrating a method of detecting an underground environment change event by analyzing a digital signal measured during a plurality of periods in an embodiment of the present invention.

FIG. 7 is a view illustrating a matching part of a control part according to an embodiment of the inventive concept.

FIG. 8 is a flowchart illustrating impedance matching of a control part in an embodiment of the present invention.

FIG. 9 is a view for explaining a Q factor in an embodiment according to the present invention.

FIG. 10 is a view illustrating the enhancement of magnetic resonance using a second coil in one embodiment of the present invention.

FIGS. 11 and 12 are views illustrating signals exchanged between a plurality of detection sensors according to an embodiment of the present invention.

FIG. 13 is a flowchart illustrating a method of detecting a change in the underground environment in an embodiment of the present invention.

### MODE FOR CARRYING OUT THE INVENTION

In the following description of the present invention, a detailed description of known functions and configurations incorporated herein will be omitted when it may obscure the subject matter of the present invention.

In the present invention, the transmission of an AC signal using magnetic induction is used to mean that an inductive coupled transmitter and receiver transmit signals in a magnetic induction manner.

Also, in the present invention, the transmission of an AC signal using magnetic resonance is used to mean transmitting a signal using a strong magnetic field coupling formed between resonance coils (a transmitter and a receiver) having the same resonance frequency.

Unless otherwise specified in the present invention, the signal sensing of the magnetic induction method is defined as including the signal sensing of the magnetic resonance method.

The present invention is to detect an underground event occurring in real time, such as occurrence of a sinkhole, by monitoring the state of the underground routinely and periodically. As mentioned in the prior art, the GPR method and the like should perform intermittent or eventual sensing by using a separate detection means, thereby exposing many limitations in terms of real-time safety management. The present inventors derive the present invention under the concept that detection of underground events should be guaranteed in terms of periodicity, continuity, and real time. As a concrete means, detection by magnetic induction method is adopted. Examples of applying the magnetic induction method to the underground are limited to electric power and communication fields such as underground communication and power transmission. However, in such a field, the transmission of signals or power by a magnetic induction method has not been activated because it may not overcome the limit of path loss. That is, the most important factor in transmitting a signal or power is to minimize the amount of signal or power loss. When the signal is transmitted through the underground, the path loss is very large.

However, the weak point of the path loss in the communication field is transformed into a very useful sensing element in the field of detecting changes in underground environment. In other words, when the medium changes, the amount of path loss changes, so that through this, changes in underground environment may be detected. Standard and abnormal conditions may be detected by changes in the amount of path loss. The present invention has an important meaning in that the weakness in the field of communication has been changed as a strength of underground event detection through the reverse idea. Hereinafter, how the underground event detection through the magnetic induction method is performed will be described in detail.

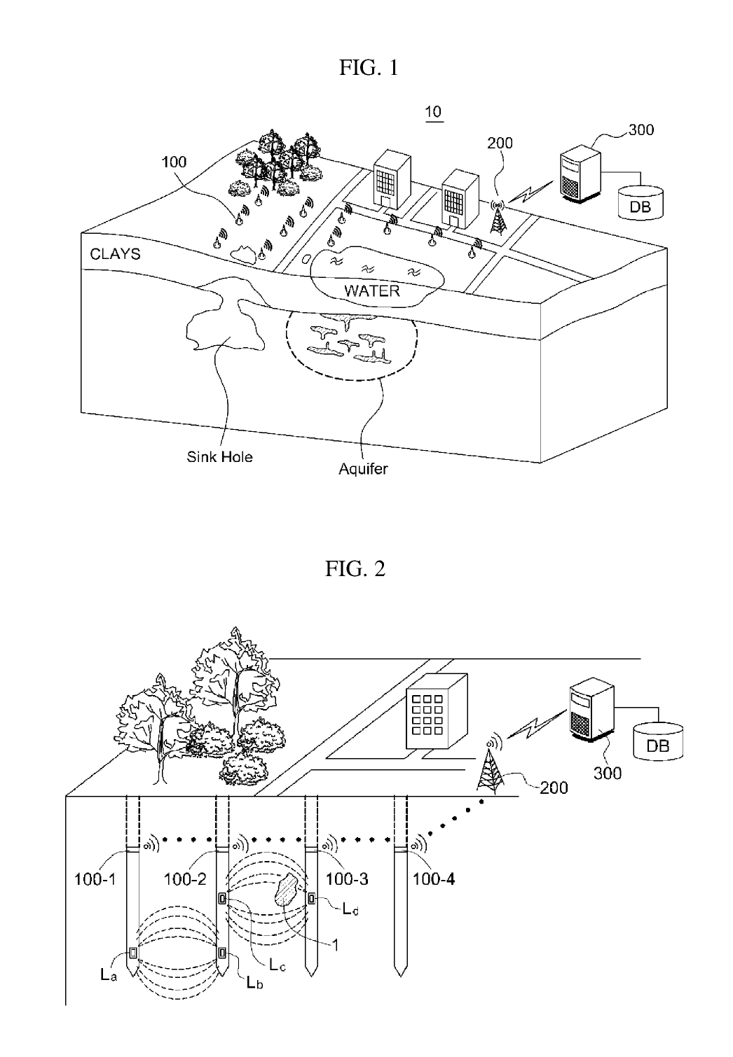

FIG. 1 is a view illustrating an underground environment change detection system according to an embodiment of the present invention. FIG. 2 is a view illustrating an underground environment change detection sensor buried in the underground in an embodiment of the present invention.

As shown in FIGS. 1 and 2, the underground environment change detection system 10 of the present invention may include a plurality of underground environment change detection sensors 100, a repeater 200, and an underground environment change detection server 300.

The plurality of underground environment change detection sensors 100 are spaced apart from each other and installed in an underground, thereby forming a sensor network. The individual detection sensors include wired or wireless communication functions. Accordingly, the sensor network of the present invention may be a sensor grid using the Internet of Things (IoT).

The plurality of underground environment change detection sensors 100 are disposed at predetermined intervals in the x and y axis directions constituting the horizontal plane. In addition, it is buried at a predetermined depth in the z-axis direction which is the depth direction.

In a preferred embodiment, the individual underground environment change detection sensor 100 may be wired or wirelessly connected to the repeater 200. However, the present invention is not limited thereto. That is, in another embodiment, the individual underground environment change detection sensor 100 may be connected to the individual underground environment change detection sensors 100 in a wired or wireless manner, instead of being connected to the repeater 200. When the individual underground environment change detection sensors 100 are connected to each other, the data output from the detection sensor may be transmitted to the underground environment change detection server 300 even when installing the repeater 200 less or not installing the repeater 200.

The detection sensor 100 is buried in the underground, and different detection sensors sense the AC signal generated in a magnetic induction manner. One detection sensor 100 may sense an AC signal, but may transmit an AC signal to another detection sensor simultaneously or with a time difference.

For example, the detection sensor 100-1 of FIG. 2 transmits an AC signal to another detection sensor 100-2 via the coil La. The AC signal is transmitted to another detection sensor 100-2 in a magnetic induction manner. The detection sensor 100-2 senses the AC signal through the coil Lb. On the other hand, the detection sensor 100-2 may transmit an AC signal to another detection sensor 100-3 through the coil Lc. Another detection sensor 100-3 senses an AC signal through the coil Ld.

The detection sensor 100 may measure the path loss according to the medium characteristic of the propagation path of the AC signal from the magnitude of the sensed AC signal. This is because the magnitude of the AC signal sensed by the detection sensor reflects the path loss due to the medium characteristics of the AC signal propagation path. For example, the magnitude of the AC signal sensed by the detection sensor 100-2 through the coil Lb will be different from the magnitude of the AC signal sensed by the detection sensor 100-3 through the coil Ld. This is because the medium 1 on the propagation path of the AC signal is different. The path loss of the AC signal may increase or decrease depending on the characteristics of the medium 1. For example, path loss may be reduced when cavities occur, and path loss may be increased when groundwater is entrained in cavities.

The repeater 200 receives signals transmitted from the plurality of detection sensors 100 and transmits the signals to the detection server 300. However, if the area where the detection sensor 100 is buried is not wide, or if the detection sensor 100 may be directly connected to the detection server 300 by wire or wirelessly, or if there is any other reason, Installation may be omitted.

The underground environment change detection server 300 analyzes the magnitude of the AC signal sensed by the plurality of detection sensors 100 to detect a change in the underground environment of the buried area.

The underground environment changes, for example, may include changes in geological environment of underground space, groundwater distribution changes, changes in urban structures including urban railways and surrounding undergrounds, and water and sewage pipe condition changes.

Accordingly, the underground environment change detection server 300 may detect the occurrence of a sinkhole, an increase in the area of the aquifer, the occurrence of a leakage of water in the water supply and sewerage pipes, the occurrence of deformation in underground structures such as gas pipes, oil pipelines, electric lines, and urban railways, or a change in moisture content in the underground of agricultural land. In addition, it is possible to monitor structural changes in hazardous facilities such as radioactive waste.

Meanwhile, the underground environment change detection system of the present invention may be combined with various application devices. For example, an underground environment change detection server may be combined with a ground sprinkler. The ground sprinkler may automatically start watering after being informed that the water content in the underground of the agricultural land is decreased.

As described above, the underground environment change detection system of the present invention aims at detecting and predicting abnormality of an underground space in advance.

The underground environment change detection server 300 detects a change in the underground environment by considering that the path loss changes as the characteristics of the medium in the propagation path of the sensed AC signal change. Since the magnitude of the sensed AC signal reflects the path loss according to the medium characteristic of the propagation path of the AC signal, the magnitude of the sensed AC signal is compared at every predetermined period, thereby detecting an underground environment change eventually.

In the above-described embodiment, when the magnitude of the AC signal is measured by the detection sensor 100, the detection server 300 analyzes the magnitude of the AC signal to detect whether or not the underground environment change occurs. However, the embodiments of the present invention are not necessarily limited thereto.

In another embodiment, the detection sensor may itself analyze the magnitude of the measured AC signal, and if the magnitude variation of the signal exceeds a predetermined threshold range, may directly determine that a change in the underground environment occurs. In this case, the detection server 300 may receive only the event occurrence result, not the magnitude of the sensed AC signal, from the detection sensor 100.

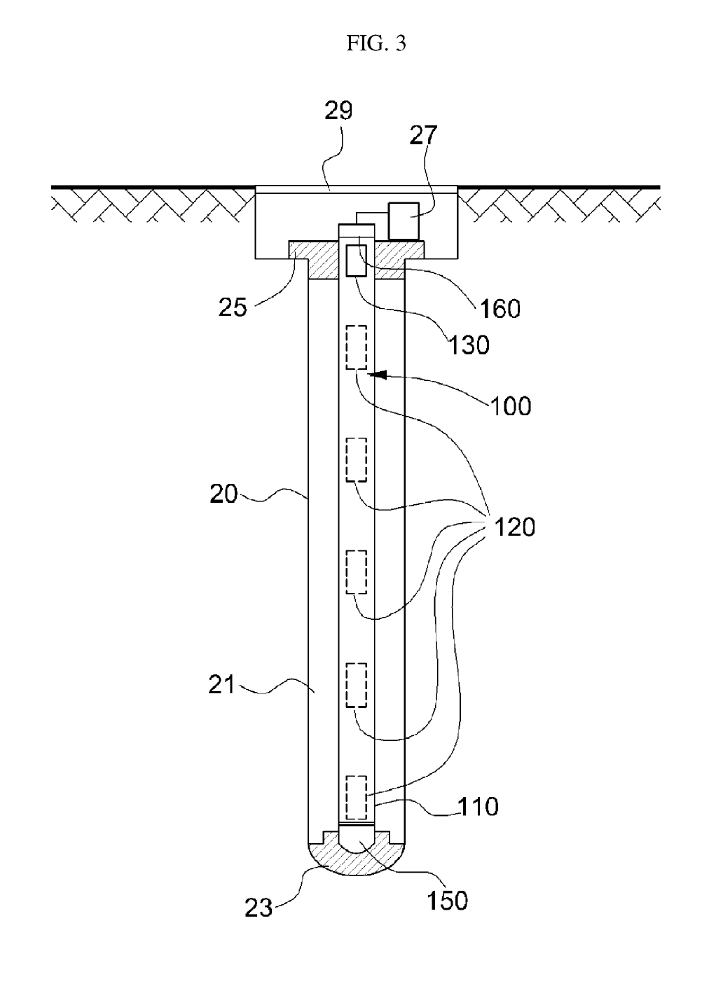

FIG. 3 is a view illustrating the configuration of an underground environment change detection sensor according to an embodiment of the present invention.

As shown in FIG. 3, in the preferred embodiment, the detection sensor 100 may be installed in the internal space 21 of the buried hole 20 formed in the underground. In an embodiment, the buried hole 20 includes a lower fixing part 23 for fixing the rotation part 150 of the detection sensor 100, an upper fixing part 25 for supporting the upper part of the detection sensor 100, a power supply part 27 for supplying power to the detection sensor 100, and an upper cover 29 covering the buried hole 20 not to expose the detection sensor 100.

In a preferred embodiment, the underground environment change detection sensor 100 includes an external case 110, a coil part 120, a control part 130, a rotation part 150, and a depth control part 160.

The external case 110 may house the coil part 120 and the control part 130 therein. The external case 110 has a dustproof and waterproof function for protecting the housed components. The external case 110 is formed of a material that does not interfere with the coil part 120 while transmitting and receiving an AC signal in a magnetic induction manner.

The coil part 120 includes a coil capable of transmitting and sensing an AC signal. The coil part 120 of the present invention may include one coil, but in the preferred embodiment, the coil part 120 may include a plurality of coils.

The coil of the present invention may include a spiral coil or a helical coil depending on the winding form of the coil but is not necessarily limited thereto.

The spiral coil may mean a coil formed in a spiral shape having a certain diameter on a virtual plane formed perpendicular to the central axis direction. The helical coil may mean a coil formed in a helical shape having a certain height along the central axis direction.

The coil part 120 of the present invention may use two or more types of coils at the same time. For example, a spiral coil may be used as the first coil part, and a helical coil may be used as the second coil part.

The helicon coil has a better directivity than the spiral coil, so that the loss of signal transmission is reduced.

The coil part of the present invention may include a first coil part and a second coil part. The second coil part may have an inductance greater than that of the first coil part, or may be a coil having a different coil shape from the first coil part. For example, the first coil part may be a spiral coil and the second coil part may be a helical coil.

In an embodiment, the second coil part may interlock with at least two first coil parts to sense or transmit the signal. For example, a structure in which four first coil parts cooperate with one second coil part may be formed. For this, the size of the first coil part may be smaller than the size of the second coil part.

In one embodiment, the coil part 120 may include a plurality of coils spaced at predetermined intervals in the depth direction (z-axis direction).

In another embodiment, the coil part 120 may include at least two coils of different sizes with different inductances. Increasing the Q-factor by using coils of different characteristics at the same time may enhance magnetic resonance. A detailed description thereof will be given later with reference to FIG. 10.

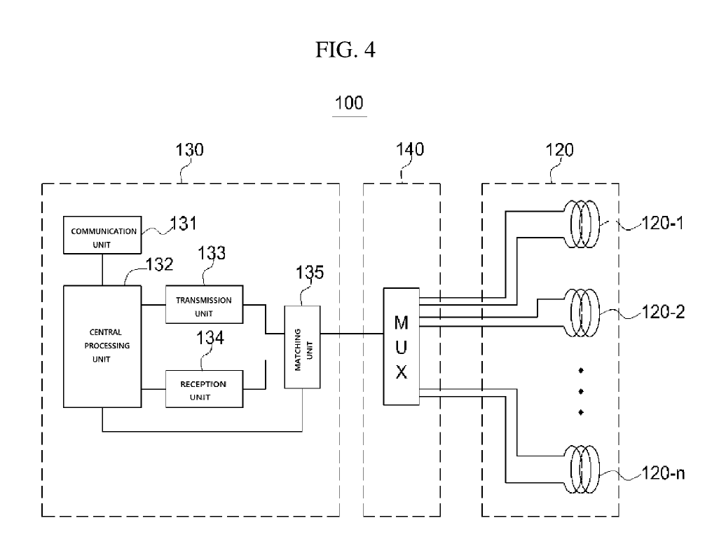

The control part 130 is disposed in the inner space (or outer space) of the external case 110 and is connected to the coil part 120. The control part 130 controls the transmission and reception of the AC signals through the coil part 120. However, the specific configuration of the control unit 130 will be described later with reference to FIG. 4.

The rotation part 150 rotates the coil part 120 to adjust the direction in which the coil part 120 is oriented. If the direction in which the coil part 120 is directed is adjusted, the sensing efficiency of the AC signal may be increased. The rotation part 150 may receive control information on the amount of rotation and the rotation time from the control part 130.

In a preferred embodiment, the rotation part 150 may be located at the lower end of the external case 110. The rotation part 150 is fixed to the lower fixing part 23 to prevent the rotation part 150 itself from loosening on the fixing part 23.

In another embodiment, the rotation part may be placed in the external case's inner space. In addition, a plurality of rotation parts may be provided, and a plurality of rotation parts may be installed respectively for a plurality of coils constituting the coil part 120. In this embodiment, the directions in which the plurality of coils constituting the coil part 120 are directed may be controlled to be different from each other.

The depth adjustment part 160 is connected to the coil part 120 and adjusts the depth of the coil part 120. By controlling the depth of the coil, one coil may be used to transmit or receive AC signals at different depths. Therefore, the depth adjustment part 160 has an effect of sensing AC signals at different depths even with a small number of coils.

In a preferred embodiment, the depth adjustment part 160 may be installed at the upper end of the external case 110, but is not limited thereto. The depth adjustment part 160 may include a guide rail for guiding the movement of the coil part 120 and a motor for adjusting the depth of the coil part 120 in order for the depth adjustment of the coil part 120.

FIG. 4 is a view illustrating a control part configuration of an underground environment change detection sensor according to an embodiment of the present invention.

As shown in FIG. 4, a detection sensor 100 may include a coil part 120 and a control part 130. A multiplexer 140 may further be provided between the coil part 120 and the control part 130. The multiplexer 140 may connect a plurality of coils 120-1 to 120-n included in the coil part to one control part 130.

The control part 130 may include a communication unit 131, a central processing unit 132, a transmission unit 133, a reception unit 134, and a matching unit 135.

The communication unit 131 includes a wireless or wired communication module. The communication unit 131 may communicate with a plurality of detection sensors, communicate with a repeater, or communicate with a detection server. The communication unit 131 may transmit the AC signal magnitude measured by the detection sensor or the detection result of the underground environment change of the control part 130 and the like.

The central processing unit 132 is connected to the communication unit 131, the transmission unit 133, the reception unit 134, and the matching unit 135, and may execute the built-in firmware to organically operate the respective components.

The transmission unit 133 transmits an AC signal. In a preferred embodiment, the transmission unit 133 may include an oscillator for AC signal oscillation, and an amplifier for amplifying the oscillated signal. The AC signal oscillated in the transmission unit 133 is transmitted to the other detection sensor in a magnetic induction manner through the coil part 120.

The reception unit 134 senses the AC signal through the coil part 120. In a preferred embodiment, the reception unit 134 may include a rectifier for rectifying the sensed AC signal, and an analog-to-digital converter for converting the rectified analog signal to a digital signal. In another embodiment, the reception unit 134 may include a down conversion mixer for lowering and outputting a frequency.

In a preferred embodiment, one control part includes a transmission unit and a reception unit, and the transmission unit and the reception unit may be connected to a single coil part. That is, the transmission unit and the reception unit may both transmit and sense signals through the same coil. In this embodiment, the control part blocks the operation of the reception unit when the transmission unit is operated, and blocks the operation of the transmission unit when the reception unit is operated.

However, the present invention is not necessarily limited to these embodiments. In another embodiment, the transmission unit is connected to the first coil group among the plurality of coils included in the coil part 120, and the reception unit may be connected to the second coil group among the plurality of coils included in the coil part 120. The first coil group is a coil different from the second coil group. For example, a transmission unit may be connected to an odd-numbered coil, and a reception unit may be connected to an even-numbered coil. In this embodiment, the control part may simultaneously transmit and sense an AC signal by simultaneously using the first coil group and the second coil group.

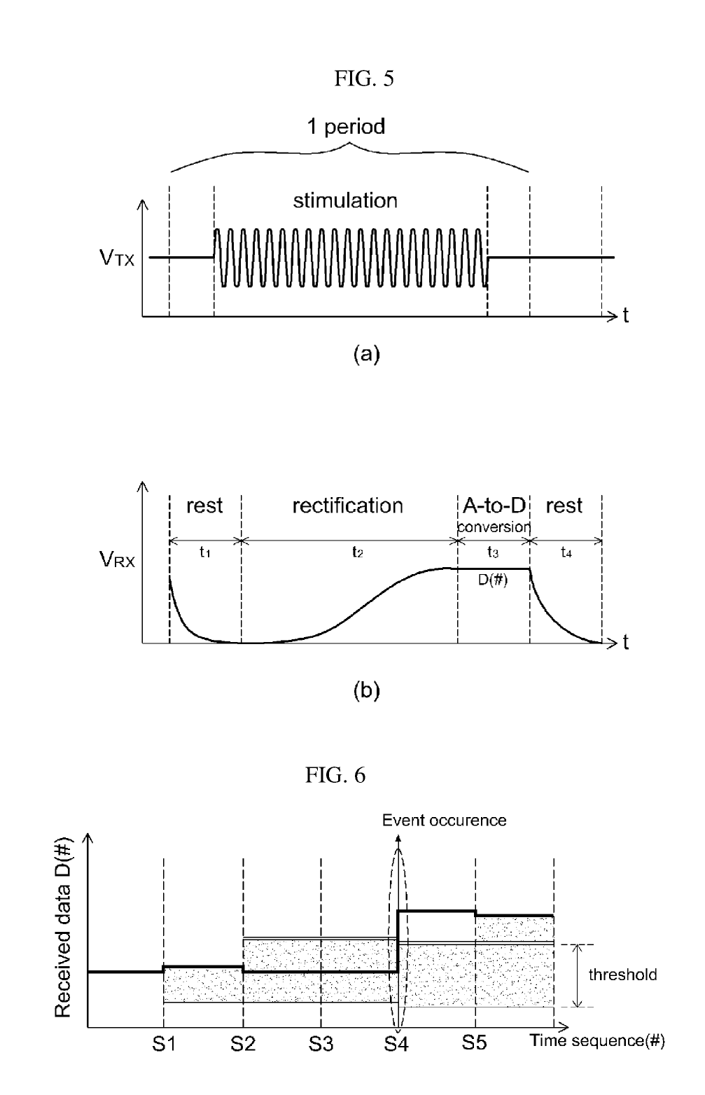

The operations of the transmission unit and the reception unit will be described in more detail with reference to FIGS. 5 and 6.

FIG. 5 is a view illustrating signal processing of a transmission unit and a reception unit in an embodiment of the present invention. FIG. 5(a) shows a signal transmitted from a transmission unit during one period, and FIG. 5(b) shows a process of processing a sensed signal.

As shown in FIG. 5(a), the transmission unit oscillates a specific AC signal for one period. There may be a predetermined pause time at the beginning and end of one period.

As shown in FIG. 5(b), the reception unit resets the circuit for a predetermined time at t1 and then rectifies the input signal at t2. Thereafter, the rectified analog signal is converted into a digital signal at t3. After the conversion, the circuit is reset again for a predetermined time at t4.

FIG. 6 is a view illustrating a method of detecting an underground environment change event by analyzing a digital signal measured during a plurality of periods in an embodiment of the present invention. The subject that detects the underground environment change event may be a detection sensor or a detection server as described above.

In order to set a threshold as shown in FIG. 6, before first starting to monitor the underground environment change, for example, immediately after the detection sensor is buried, an AC signal is exchanged between two different detection sensors to generate reference data (although other embodiments may not generate such reference data).

Then, a predetermined threshold range is set above and below the reference data on the basis of the reference data.

Then, start the period S1 and start monitoring the underground environment change in earnest. In the case where the anomaly does not occur as in the periods S1 to S3, the measured digital signal does not exceed the predetermined threshold range.

However, when anomaly such as the period S4 occurs, the measured digital signal deviates from the threshold range. If the digital signal is out of the threshold range, it may be determined that a change in the underground environment occurs.

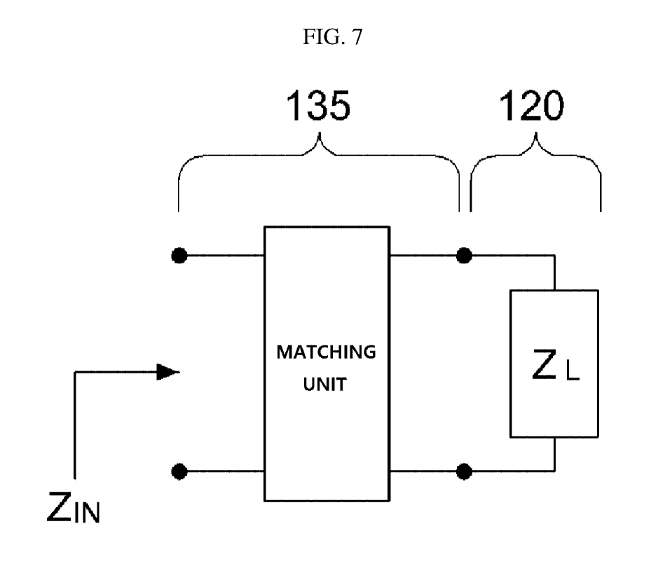

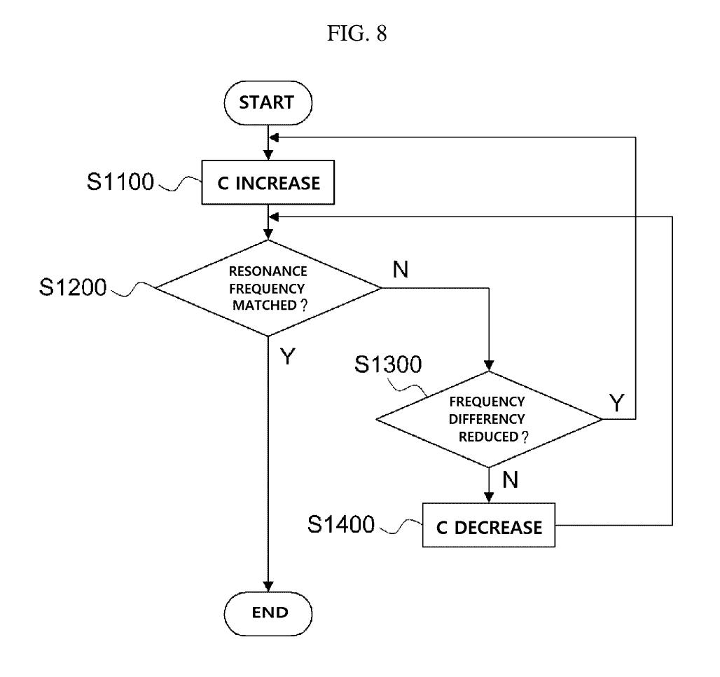

FIG. 7 is a view for explaining a matching part of a control part in an embodiment of the present invention.

The matching part 135 matches the impedance to efficiently transmit and sense the AC signal. That is, the resonance frequency between the transmitting side and the receiving side is matched through impedance matching, thereby increasing the efficiency of signal sensing.

In a preferred embodiment, the matching part 135 may include at least one variable capacitor. At least one or more variable capacitors may be connected to the coil in series, parallel, or series-parallel hybrid structures.

The matching part 135 may adjust the capacitance of the variable capacitors included in the matching part 135 to adjust the impedance ZIN of the coil part 120 and the matching part 135.

The control part may control the matching part for impedance matching. To explain this in more detail, FIG. 8 will be referred as follows.

FIG. 8 is a flowchart illustrating impedance matching of a control part in an embodiment of the present invention.

As shown in FIG. 8, if it is determined that the resonance frequencies do not match, the control part first increases the capacitance of the matching part for impedance matching (S1100).

Next, the AC signal is sensed again and it is determined whether the measured frequency and the resonance frequency match (S1200).

If the resonance frequencies do not match, it is checked whether the difference between the resonance frequency and the measured frequency is decreased (S1300).

If the frequency difference is decreased, go back to increasing the capacitance (S1100) and repeat the above steps.

If the frequency difference is increased, it means that increasing the capacitance is matching in the wrong direction, so the capacitance is decreased (S1400). After decreasing the capacitance, operations S1200 and S1300 are repeated to match the resonance frequencies.

Although the impedance matching is started first in the direction of increasing the capacitance (S1100) in the embodiment as described above, in another embodiment, impedance matching may be started in a direction that reduces the impedance.

By matching the resonance frequencies of the receiving and receiving points through impedance matching, AC signals may be transmitted more efficiently.

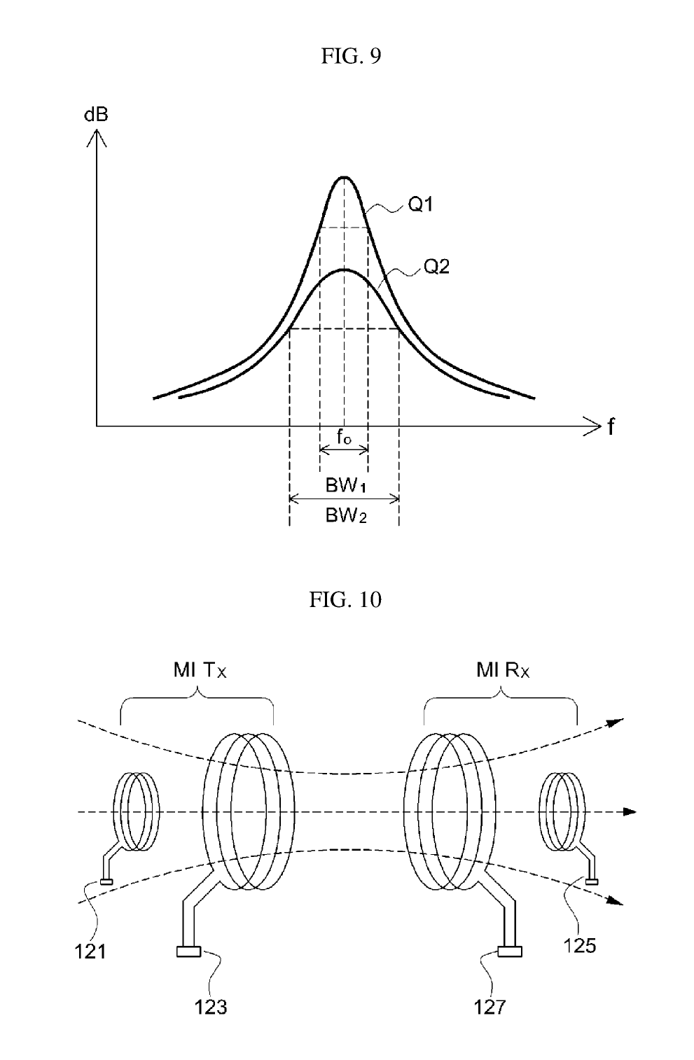

FIG. 9 is a view for explaining a Q factor in an embodiment according to the present invention.

The present invention further considers a Q factor in addition to the impedance matching on the basis of a resonance frequency f0.

In wireless communication, a coil having a low Q factor is used in consideration of data capacity. That is, the Q factor Q2 is lowered to secure the wide bandwidth BW2.

However, the present invention is not directed to wireless communication for transmitting and receiving data. An object of the present invention is to provide a sensor for sensing a change in the underground environment using a magnetic induction method. Therefore, in order to secure a longer sensing distance and a higher sensor sensitivity, a coil having a high Q factor Q1 is used at the expense of the bandwidth BW1.

When it is defined that f is a resonance frequency, L is the inductance of a coil, and r is the internal resistance of a coil, the Q factor Q may be defined by the following equation.

Q=wL/r, where w=2πf

Therefore, by using a material with a large L and a small r, the Q factor of the coil may be increased.

However, when the Q factor is large, the sensitivity of the sensor increases together, resulting in a decrease in stability. Therefore, it is necessary to design an appropriate Q factor according to the installation purpose of the sensor, installation place and installation interval, and underground medium characteristics.

FIG. 10 is a view illustrating the enhancement of magnetic resonance using a second coil in one embodiment of the present invention.

The coil part 120 of FIG. 4 of the present invention may include first coil part 121 and 125 and second coil part 123 and 127.

The first transmission coil 121 and the second transmission coil 123 are coils included in the transmission unit. The first reception coil 125 and the second reception coil 127 are coils included in the reception unit. The AC signals transmitted from the first transmission coil 121 and the second transmission coil 123 are transmitted to the first reception coil 125 and the second reception coil 127 through a strong magnetic field coupling.

In a preferred embodiment, the second coil parts 123 and 127 have a higher inductance than the first coil parts 121 and 125.

When using the second coil parts 123 and 127, the resonance characteristics may be enhanced by raising the Q factor of the transmission unit and the reception unit.

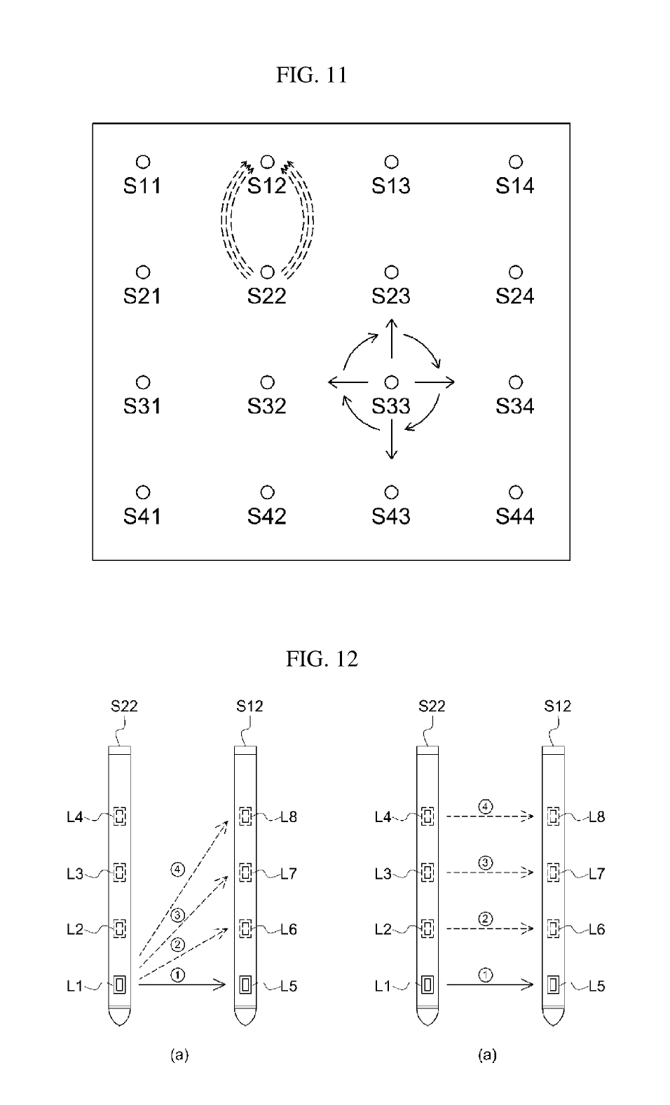

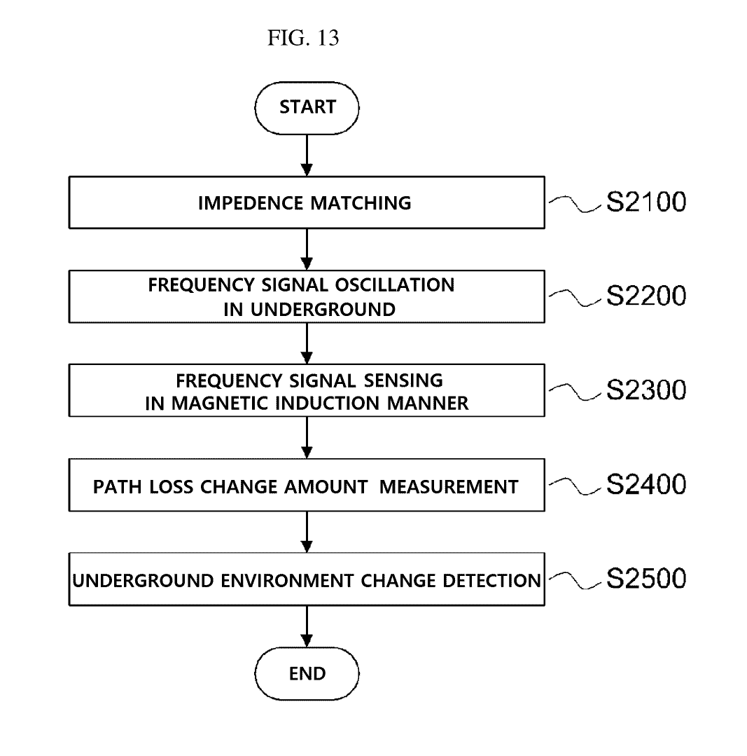

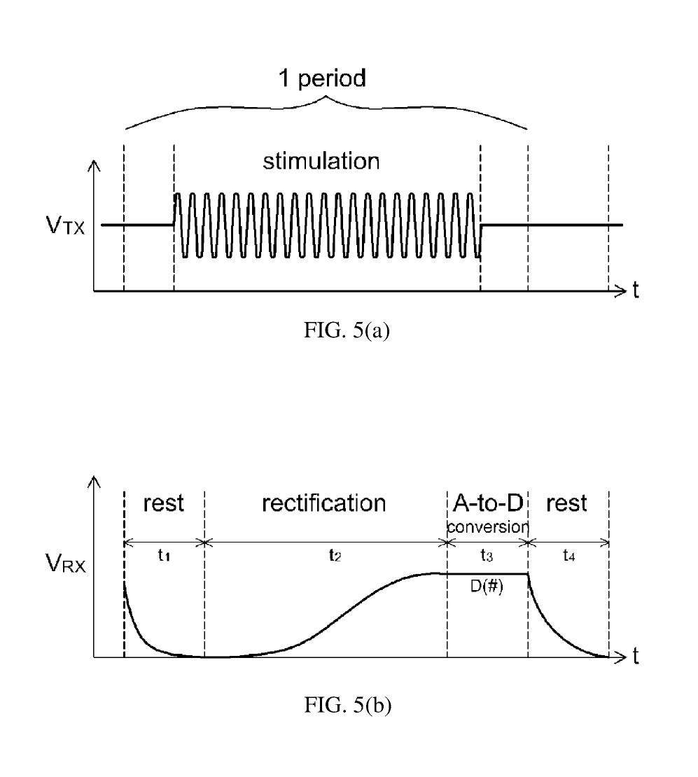

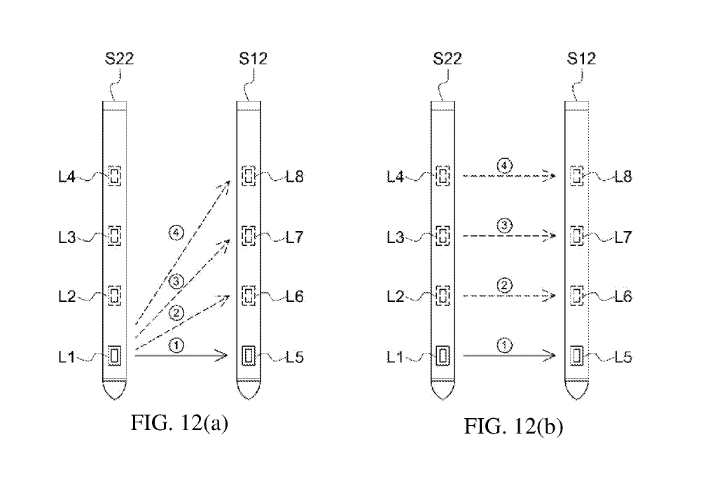

FIGS. 11 and 12 are views illustrating signals exchanged between a plurality of detection sensors according to an embodiment of the present invention.

FIG. 11 is a plan view illustrating a specific area in which a plurality of detection sensors S11 to S44 are buried, and FIG. 12 is a sectional view for explaining reception of signals among a plurality of detection sensors.

The plurality of detection sensors shown in FIG. 11 form one sensor network. Sensors included in a sensor network exchange AC signals with each other. There may be various embodiments of the order in which the AC signals are exchanged between the detection sensors.

In one embodiment, when the detection sensors in S11 to S14 sequentially transmit the AC signals, the remaining detection sensors may receive the signals. Thereafter, the detection sensors in the next columns, S21 to S24, may proceed in such a manner that the AC signals are sequentially transmitted. For example, when the detection sensor in S11 transmits a signal, adjacent detection sensors in S12 and S21 may receive the signal. Next, when the detection sensors in S12 transmit a signal, the detection sensors in S11, S13, and S22 may receive the signal.

In another embodiment, one detection sensor may transmit signals to another adjacent detection sensor during rotation. For example, the detection sensors in S33 may rotate using the rotation part 150 in FIG. 3 and transmit a signal. The detection sensors in S33 may turn toward S34 after transmitting signals toward the detection sensors in S23. In the same manner, the detection sensors in S33 may rotate toward the detection sensors in S43 after transmitting signals toward S34. As described above, when the detection sensor is directed to the adjacent detection sensor and transmits a signal, the transmission/reception efficiency is increased.

As shown in FIG. 12, the plurality of coils included in one detection sensor may transmit and receive signals with a time difference depending on the depth.

In the embodiment as shown in FIG. 12(a), the coil L1 may sequentially transmit signals in the direction of the coils L5, L6, L7, and L8. In the embodiment as shown in FIG. 12(b), after the coil L1 transmits a signal toward the coil L5, the coil L4 coil transmits a signal toward the coil L8 in a manner that the coil L2 transmits a signal toward the coil L6.

By combining the embodiments of FIGS. 11 and 12, it is possible to collect three-dimensional path loss change data for an underground three-dimensional space in which a plurality of detection sensors are buried. In addition, by using this, a three-dimensional space map indicating the path loss of the three-dimensional space may be created.

FIG. 13 is a flowchart illustrating a method of detecting a change in the underground environment in an embodiment of the present invention.

As shown in FIG. 13, the detection sensor matches the impedance with another detection sensor (S2100) before or after the underground environment change detection sensor is buried in the underground. Matching the impedances may increase the magnetic resonance efficiency.

Next, the detection sensor transmits an AC signal in an underground (S2200).

Next, the detection sensor senses the AC signal transmitted through the magnetic induction method using the first coil (S2300).

Specifically, the detection sensor measures the magnitude of the sensed AC signal. Since the magnitude of the sensed AC signal reflects the path loss according to the medium characteristic of the propagation path of the AC signal, measuring the magnitude of the signal may measure path loss.

In a preferred embodiment, the detection sensor performs the operations of rectifying the sensed AC signal to output an analog signal and outputting the analog signal as a digital signal, so that the magnitude of the sensed signal may be quantified. As described above, when using the magnitude change of the digital signal, the path loss change due to the underground environment change on the signal transmission path may be known.

In another embodiment, the detection sensor may sense the AC signal by simultaneously using a first coil and a second coil having a greater inductance than the first coil to enhance magnetic resonance.

Next, the detection sensor repeats the operations of transmitting and sensing the signal at predetermined periods to measure the path loss variation according to the time variation (S2400).

Next, the detection sensor or the detection server determines that the underground environment change event occurs when the path loss variation due to the time transition is out of the predetermined threshold range (S2500).

In another embodiment, in relation to the underground environment change detection method, first, a plurality of detection sensors, which are buried in the underground three-dimensional space and are spaced a predetermined distance apart from each other in the X, Y, and Z directions, transmit and receive signals every predetermined period in the underground through a magnetic induction manner.

Next, the underground environment change detection server analyzes signals transmitted and received between the plurality of detection sensors during one period, and extracts three-dimensional path loss data that records path loss between each detection sensor.

Next, the underground environment change detection server analyzes the three-dimensional path loss data extracted every a plurality of periods to generate a three-dimensional path loss change amount database according to the time transition.

Next, the underground environment change detection server analyzes the three-dimensional path loss change amount database and determines that an underground environment change event occurs when a change of a predetermined threshold value or more is detected.

In another embodiment, the underground environment change detection server analyzes the three-dimensional path loss change amount database to notify occurrence of an underground environment change event when path loss occurs consecutively for a predetermined period or more. When a change of the threshold value or more is not detected but the path loss increases or decreases continuously more than a predetermined period and thus the change of the threshold value or more is predicted, this may be expected.

Next, the underground environment change detection server displays the position of at least two detection sensors where the underground environment change event occurs, on the map where the detection sensor is buried, and displays the underground environment event occurrence on the space between at least two displayed detection sensors.

The underground environment change events may include at least one of sinkhole occurrence, water and sewage leakage, underground structure deformation, and agricultural land moisture content reduction. That is, the present invention may expect that a cavity occurs when a sinkhole occurs, water and sewerage leaks increase the underground water content, an underground structure is damaged or deformed, and soil moisture content of agricultural land is reduced, so that water supply is needed.

### Another Embodiment

In another embodiment of the present invention, the reception unit may be buried in the underground and the transmission unit may be located on the ground.

In another embodiment of the present invention, both the transmission unit and the reception unit may be buried on the ground. In this case, the signal transmitted from the transmission unit may be received by the reception unit through the underground. In some cases, a reflection device may be further included to reflect the transmission signal and transmit it to the reception unit.

In another embodiment of the present invention, the transmission unit and the reception unit may be included in one detection sensor or may be included in different detection sensors.

The protected scope of the present invention is not limited to the description and the expression of the embodiments explicitly described above. It is again added that the protected scope of the present invention is not limited by obvious changes or substitutions in the technical field to which the present invention belongs.

1. An underground environment change detection method comprising:
repeatedly sensing an AC signal propagated through an underground in a magnetic induction manner; and
monitoring an underground environment change from a change in the AC signal.

2. The method of claim 1, wherein the monitoring of the underground environment change comprises determining that an underground environment change occurs when the AC signal is out of a threshold range.

3. The method of claim 1, wherein the monitoring of the underground environment change comprises warning an occurrence of an underground environment change when the AC signal is continuously increased or decreased more than a threshold count.

4. The method of claim 1, wherein the monitoring of the underground environment change comprises:
measuring a path loss change amount according to a change in a medium property on a path through which the AC signal propagates, from a change in the AC signal; and
detecting an underground environment change by using the path loss change amount.

5. The method of claim 1, further comprising matching an impedance between detection sensors transmitting and receiving an AC signal before the sensing of the AC signal.

6. An underground environment change detection sensor comprising:
a coil part configured to sense an AC signal propagated through an underground in a magnetic induction manner; and
a control part configured to repeatedly sense the AC signal to measure a change amount of the AC signal.

7. The sensor of claim 6, wherein the coil part senses the AC signal in a magnetic resonance manner.

8. The sensor of claim 7, wherein the coil part comprises a first coil part and a second coil part having an inductance greater than that of the first coil part.

9. The sensor of claim 8, wherein the first coil part is a spiral coil and the second coil part is a helical coil.

10. The sensor of claim 8, wherein the second coil part is interlocked with at least two first coil parts to sense the AC signal.

11. The sensor of claim 6, further comprising a matching part including at least one variable capacitor,
wherein the control part adjusts a capacitance of a variable capacitor to perform impedance matching with another underground environment change detection sensor.

12. The sensor of claim 6, wherein the coil part comprises at least two coils spaced apart from each other in an underground depth direction.

13. An underground environment change detection system comprising:
a plurality of underground environment change detection sensors configured to repeatedly transmit and receive an AC signal propagated through the underground in a self-induction manner; and
an underground environment change detection server configured to monitor an underground environment change from a change in the AC signal received by the plurality of underground environment change detection sensors.

14. An underground environment change detection system comprising:
at least one first detection sensor configured to transmit an AC signal in a magnetic induction manner;
at least one second detection sensor configured to sense the AC signal propagated through the underground, being spaced apart from the first detection sensor; and
an underground environment change detection server configured to repeatedly measure a change amount of the AC signal sensed by the second detection sensor to detect an underground environment change.

15. The system of claim 13, wherein the underground environment change detection server monitors at least one of changes in geological environment of underground space, groundwater distribution changes, deformations of underground structures including at least one of water supply and drainage pipes, gas pipes, oil pipelines, electric lines, and urban railways, and their surrounding ground changes.
